(19) United States
(12) Patent Application Publication
(10) Pub. No.: US 2008/0302583 A1
(43) Pub. Date: Dec. 11, 2008

(54) Gas Cell for Electrostatic Induction Type Touch Input Device

(76) Inventor: Kazuo Tateishi, Tokyo (JP)

Correspondence Address: Martin A. Farber, 866 United Nations Plaza, Suite 473, New York, NY, 10017, US

(21) Appl. No.: 11/658,687

(22) PCT Filed: Sep. 27, 2005
(86) PCT No.: PCT/JP05/18236

§ 371 Date: Feb. 1, 2008

(30) Foreign Application Priority Data
Sep. 27, 2004 (JP) 2004-280019
Sep. 22, 2005 (JP) 2005-276465

(51) Int. Cl. G06F 3/046; G06F 3/041

(52) U.S. Cl. 178/18.07; 178/18.03

(57) ABSTRACT

A touch input device is provided which can improve considerably an optical transmittance without using dot spacers. A gas cell for a touch input device has: a parallel plate member 2 including two flat plates disposed in parallel and facing each other; a diaphragm 5 for sealing a peripheral portion of the parallel plate member 2 in such a manner that gas is accommodated in a gap between the two flat plates in a state that the two flat plates can conduct relative displacement along opposing directions; and a frame 7 for holding the peripheral portion of the parallel plate member 2 in such a manner that the two flat plates can conduct the relative displacement. In this invention, best touch sense is realized by utilizing elasticity of gas. A further feature resides in that the touch sense can be adjusted freely by a simple method. Each switch element adopts an electrostatic induction method. With this method, an ON/OFF operation of a switching circuit and a selection operation of a switch position can be conducted independently. An ON/OFF mechanism can be shared by all switches irrespective of the number of switches.

### TECHNICAL FIELD

The present invention relates to a gas cell for a touch input device such as a touch panel and a push button switch, and more particularly to a gas cell for an electrostatic induction type touch input device.

### BACKGROUND ART

A touch input device for conducting an input by contacting a panel type keyboard with a finger is widely used with a personal computer, an automatic teller machine, a ticket vending machine and the like.

A main trend of a touch input device to date uses a resistor film.

As shown in FIG. 8, a resistor film type touch input device 101 has resistor film sheets 102 and 103, the gap therebetween being maintained by dot spacers 104. A pair of resistor film sheets 102 and 103 is spaced apart by the dot spacers unless an input with a finger or the like is conducted. However, upon an input operation, the resistor film sheets contact so that a voltage change appears to effect the input (refer to Patent Document 1).

Patent Document 1: Japanese Patent Laid-open Publication No. HEI-8-54977

Various developments have been made for this resistor film type touch input device. A main point of technical developments is a total optical transmittance of a panel. Dot spacers are considered most adversely affecting the total optical transmittance. Dot spacers not only intercept light but also cause refraction, irregular reflection, moire stripes, which are the most significant factors of performance degradation.

However, there is a limit in improving a panel total optical transmittance of a resistor film type touch input device which has dot spacers as essential constituent elements for maintaining a gap between two plate members and retaining a stroke of the plate member.

The present invention has been made in consideration of the above-described circumstance, and it is an object of the present invention to provide a touch input device capable of improving an optical transmittance considerably without using dot spacers.

### DISCLOSURE OF THE INVENTION

In order to achieve the above object, the present invention provides a gas cell for a touch input device comprising: a parallel plate member including two flat plates disposed in parallel and facing each other and having a plurality of electrodes; a sealing member for sealing a peripheral portion of the parallel plate member in such a manner that gas is accommodated in a gap between the two flat plates in a state that the two flat plates can conduct relative displacement along opposing directions; and a frame for holding the peripheral portion of the parallel plate member in such a manner that the two flat plates can conduct the relative displacement along opposing directions.

The present invention also provides a gas cell for an electrostatic induction type touch input device comprising: a parallel plate member including two flat plates disposed in parallel and facing each other and having a plurality of conductive wires and electrodes; a sealing member being mounted on a peripheral portion of the parallel plate member for sealing the peripheral portion of the parallel plate member in such a manner that gas is accommodated in a gap between the two flat plates in a state that the two flat plates can conduct relative displacement along opposing directions; and a frame for holding the peripheral portion of the parallel plate member in such a manner that the two flat plates can conduct the relative displacement along opposing directions.

### ADVANTAGES OF THE INVENTION

For a touch input device such as a touch panel also called a human-machine interface, it is a matter of course that whether a touch sense during operation is bad or good is the most important issue. According to conventional techniques, this issue is apt to be disregarded, and few touch input devices can instruct a machine or instrument with satisfactorily good touch sense. The present invention realizes best touch sense by utilizing elasticity of gas. A further characteristic feature of the invention resides in that the touch sense can be adjusted freely by a simple approach.

Many touch panels such as a resistor film type touch panel use “dot spacers” of elastic polymer material in order to realize stroke and depression sense of a switch. However, dot spacers become a very large obstacle when considering the present situation that the most important issue of technical developments is a persistent pursuit of transparency. This contradiction can be overcome completely by an “air spacer” of the invention which uses gas.

Further, the present invention employs a non-contact type for each switch element constituting a number of switch groups. This non-contact type perfectly solves the problem of contact failure and temporal change which is a critical issue of switch.

Each switch element adopts an electrostatic induction method. With this method, an ON/OFF operation of a switching circuit and a selection operation of a switch position can be performed separately. Therefore, an ON/OFF mechanism can be shared by all switches independent from the number of switches (only one ON/OFF mechanism is sufficient). This condition is essential for allowing the present invention to be practically used. More specifically, a target switch in a number of matrix switch groups can be selected merely by moving a finger near to the switch. After the finger touches the switch and depresses it, an ON condition is satisfied for all switch groups. However, this condition is made invalid for the switches other than the selected switch. It is therefore judged that only the target switch is ON, and it is possible to prevent an erroneous operation to be caused by “touching wrong switch” which is one issue associated with a touch panel.

Since elasticity of gas is utilized as a spring mechanism of switch, there is a large advantage over conventional elastic materials such as rubber, polymer, and metal spring. Namely, these conventional elastic materials have essentially a limited lifetime due to material fatigue. Gas, particularly air, exists inexhaustibly and if gas can be replenished by one operation as proposed in the present invention, it is not necessary at all to consider the lifetime of switch.

A further advantage is low cost. The whole mechanism is constituted of only upper and lower transparent electrode plates and a peripheral diaphragm, realizing a quite simple and plain structure and dispensing complicated adjustment. Furthermore, since there is no fear of failure of contact points, degradation and exhaustion of constituent components and the like, there is considerable advantages in terms of manufacture cost and maintenance cost.

The invention, particularly the invention described in claim 1, can realize good touch sense by utilizing gas elasticity. Moreover, this touch sense can be freely adjusted by changing the pressure of gas loaded in the space in a plate member. Since dot spacers are not used, a touch panel having a high transparency can be realized.

Further, since switch elements constituting a number of switch groups are non-contact, problems of contact failure and temporal change will not occur. Furthermore, since a switch position can be selected and all switches share the ON/OFF mechanism, it is possible to prevent an erroneous input from other switches after one switch is selected. Moreover, the invention uses air as a spacer without using dot spacers so that a touch panel can be manufactured inexpensively.

The invention described in claim 2 can make smooth a relative displacement of a parallel plate member.

The invention described in claim 3 can facilitate a supply of air constituting the air spacer.

The invention described in claim 4 can improve a total optical transmittance of a touch panel.

The invention described in claim 5 can improve a total optical transmittance of a touch panel.

The invention described in claim 6 can facilitate to identify a switch position.

The invention described in claim 7 can improve a total optical transmittance of a touch panel.

The invention described in claim 8 can easily configure an electrostatic induction type touch panel.

The invention described in claim 9 can easily configure an electrostatic induction type touch panel in particular.

The invention described in claim 10 can easily identify the position of a switch.

The invention described in claim 11 can adjust the characteristics of a touch panel and configure the touch panel having a stable performance.

The invention described in claim 12 can realize good touch sense by utilizing gas elasticity. Moreover, this touch sense can be freely adjusted by changing the pressure of gas loaded in the space in a plate member. Since dot spacers are not used, a touch panel having a high transparency can be realized.

Further, since switch elements constituting a number of switch groups are non-contact, problems of contact failure and temporal change will not occur. Furthermore, since a switch position can be selected and all switches share the ON/OFF mechanism, it is possible to prevent an erroneous input from other switches after one switch is selected. Moreover, the invention uses air as a spacer without using dot spacers so that a touch panel can be manufactured inexpensively.

The invention described in claim 13 can make smooth a relative displacement of a parallel plate member.

The invention described in claim 14 can facilitate a supply of air constituting the air spacer.

The invention described in claim 15 can improve a total optical transmittance of a touch panel.

The invention described in claim 16 can improve a total optical transmittance of a touch panel.

The invention described in claim 17 can facilitate to identify a switch position.

The invention described in claim 18 can improve a total optical transmittance of a touch panel.

The invention described in claim 19 can easily configure an electrostatic induction type touch panel.

The invention described in claim 20 can easily configure an electrostatic induction type touch panel in particular.

The invention described in claim 21 can easily configure an electrostatic induction type touch panel.

The invention described in claim 22 can adjust the characteristics of a touch panel and configure the touch panel having a stable performance.

The invention described in claim 23 can improve a total optical transmittance of a touch panel.

The invention described in claim 24 can improve a total optical transmittance of a touch panel by using a mold of indium oxide ultra fine particle powder excellent in transparency.

The invention described in claim 25 can configure a touch panel capable of preventing input of external disturbance and conducting a precise operation by forming a shield layer.

The invention described in claim 26 can configure a touch panel capable of preventing interference between conductive wires and conducting a precise operation.

The invention described in claim 27 can configure a touch panel capable of facilitating mounting a diaphragm, realizing reduction in manufacture cost and providing reliable air tightness.

The invention described in claim 28 can configure a touch panel capable of facilitating supply of air between two flat plates.

The invention described in claim 29 can configure an electrostatic induction type touch panel capable of preventing erroneous input operation.

### BRIEF DESCRIPTION OF THE DRAWINGS

FIG. 1 is an illustrative plan view of a gas cell for a touch input device.

FIG. 2 is an illustrative front view of the gas cell for a touch input device.

FIG. 3 is an illustrative side view of the gas cell for a touch input device.

FIG. 4 is an illustrative perspective view of a reflection electrode and an input/output electrode.

FIG. 5 is an illustrative cross sectional view showing an operation state of the gas cell for a touch input device.

FIG. 6 is a graph showing a voltage change.

FIG. 7 is a graph showing the characteristics of a charged pressure relative to deflection of a gas cell.

FIG. 8 is an illustrative vertical cross sectional view of a conventional panel for a touch input device.

FIG. 9 is an illustrative diagram showing a uniformly distributed load on a four-side supported rectangle plate.

FIG. 10 is an illustrative front view of another gas cell for a touch panel input device.

FIG. 11 is an illustrative lateral cross sectional view of another gas cell for a touch input device.

FIG. 12 is an illustrative enlarged view of a portion B in FIG. 11.

FIG. 13 is illustrative partial lateral cross sectional views of an air supply unit.

FIG. 14 is an illustrative enlarged cross sectional view of a diaphragm.

FIG. 15 is an illustrative partial perspective view of a parallel plate member.

FIG. 16 is an illustrative cross sectional view showing an operation state of a gas cell for an electrostatic induction type touch input device.

FIG. 17 is a graph showing a voltage change.

FIG. 18 is a plan view of another parallel plate member.

FIG. 19 is an illustrative cross sectional view taken along line A-A′ in FIG. 18.

FIG. 20 is an enlarged view of a B portion in FIG. 19.

### BEST MODE FOR CARRYING OUT THE INVENTION

Embodiments of the present invention will now be described with reference to the accompanying drawings. First, the first embodiment will be described.

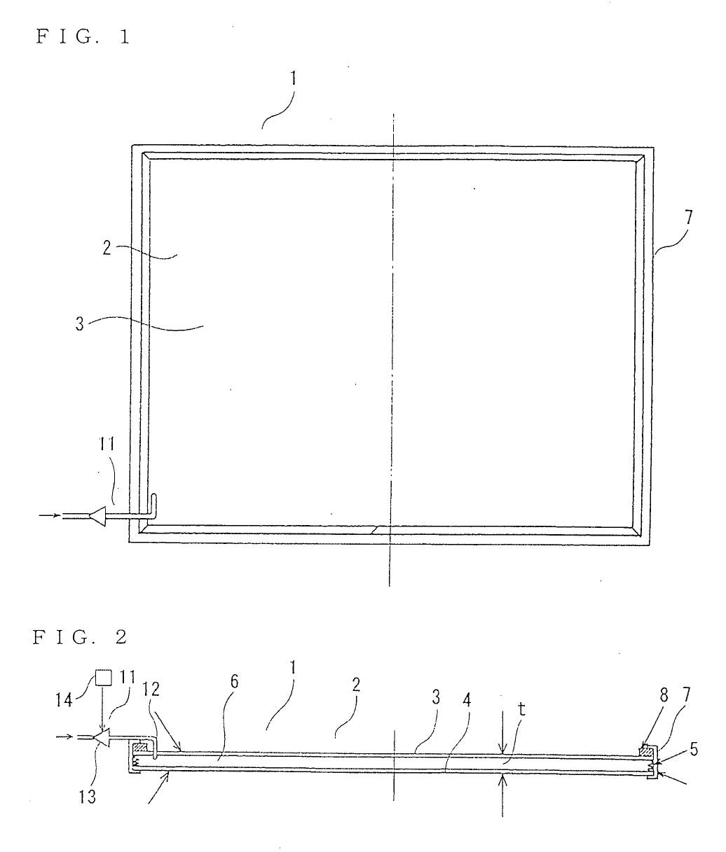

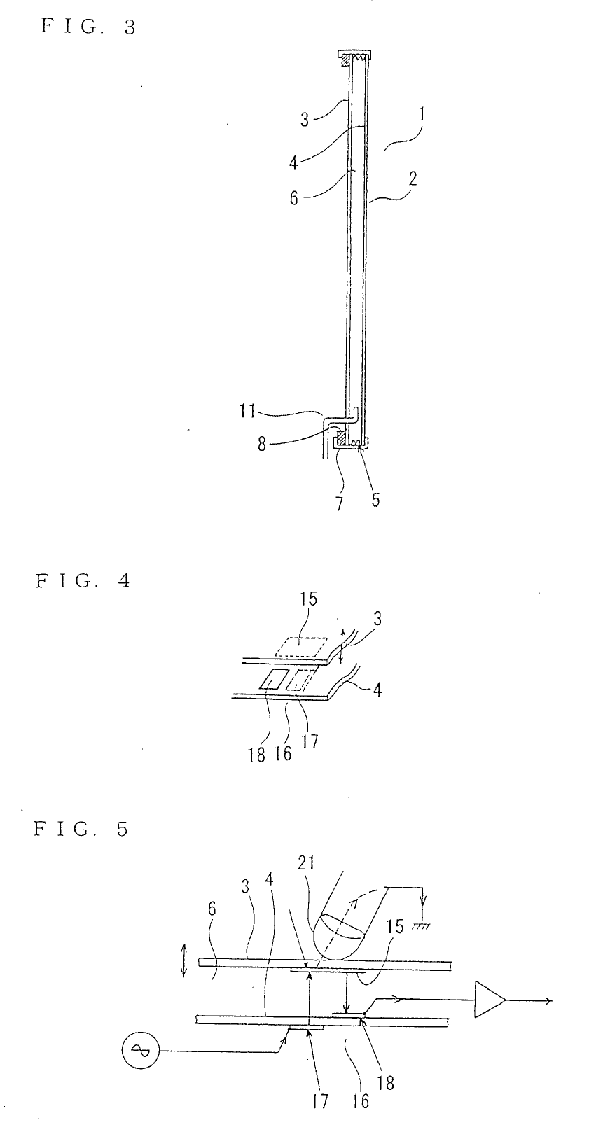

In FIGS. 1 to 3, reference numeral 1 represents a gas cell for a touch input device. The gas cell 1 for a touch input device has, if necessary, fingerprint sensors 10a, 10b and 10c. The gas cell 1 for a touch input device has a parallel plate member 2. The parallel plate member 2 is constituted of two plates disposed facing each other in parallel with a predetermined gap therebetween. In this embodiment, flat plates 3 and 4 are used as the two plates. Namely, the parallel plate member 2 is constituted of two flat plates 3 and 4. The flat plates 3 and 4 are disposed facing each other in parallel, and can perform relative displacement along mutually opposing directions. A peripheral portion of the parallel plate member 2 is sealed by a sealing member to be in an air-tight state. Therefore, the flat plates 3 and 4 are coupled in the state that the plates can perform relative displacement along mutually opposing directions and that gas can be accommodated in a gap 6 therebetween, the gap having a thickness of t. For example, a thickness of each of the flat plates 3 and 4 is 0.7 mm and a thickness t of the gap 6 is 1.5 mm. In this embodiment, a diaphragm 5 is used as the sealing member. The flat plates 3 and 4 are made of glass or plastic.

The peripheral portion of the parallel plate member 2 is fitted in a frame 7 at the outside of the diaphragm 5. For example, the frame is made of aluminum die-cast or plastic.

A stopper 8 is disposed between the parallel plate member 2 and frame 7 to regulate the range of relative displacement between the flat plates 3 and 4. Gas to be filled in the gap 6 may be air. The gas is supplied into the gap 6 by a gas supply unit 11. The gas supply unit 11 has a pipe 12, a valve 13 and a controller 14. The valve 13 is opened by a signal from the controller 14 so that air can be introduced from the pipe 12 into the gap 6. The valve 13 and controller 14 may be replaced with a rubber valve.

As shown in FIGS. 4 and 5, of the two flat plates 3 and 4 of the parallel plate member 2, one flat plate 3 has a number of reflection electrodes 15 disposed in a matrix shape on the inner surface thereof. An input/output electrode 16 is disposed on the inner surface of the other flat plate 4 in correspondence with each reflection electrode 15 generally at the position corresponding to the reflection electrode 15. This input/output electrode 16 is constituted of a pair of a drive electrode 17 and a detector electrode 18. Drive electrodes 17 disposed at the same row or column are connected the same row or column, and detector electrodes 18 disposed at the same column or row are connected to the same row or column.

Two flat plates 3 and 4 of the parallel plate member 2 are made of transparent material such as glass and plastic, and the drive electrode 17 and detector electrode 18 are also made of transparent material. For example, the reflection electrode 15, drive electrode 17 and detector electrode 18 may be formed by sputtering indium oxide. In order to shield the input/output electrodes 16 disposed on the other flat plate 4 along row and column directions, shielding is effected on the whole surface of the one flat plate 3 with the reflection electrodes 15, excepting the window-shaped surface where the reflection electrodes are formed.

Common connection wirings at each row and column of the other flat plate 4 are led to an external and connected to a high frequency signal source and a reception unit. The operation of the gas cell 1 for a touch input device constructed as above is as follows.

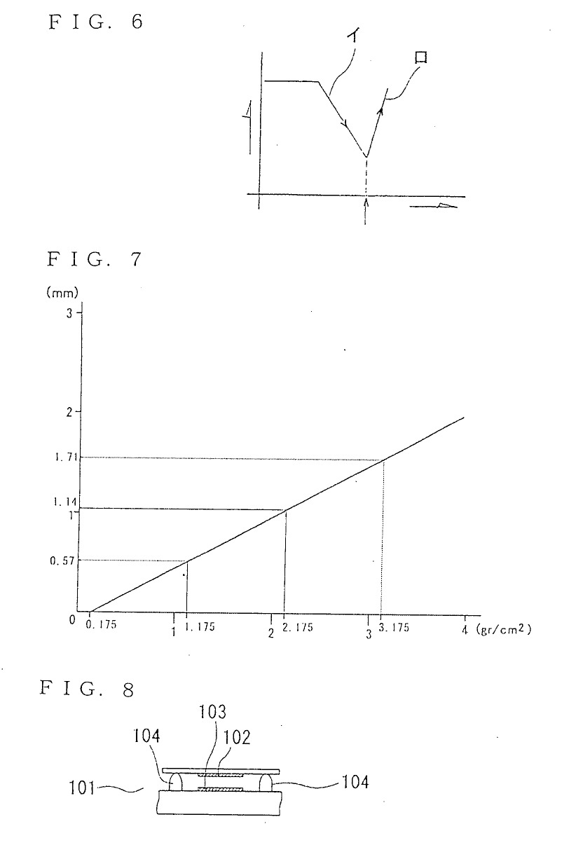

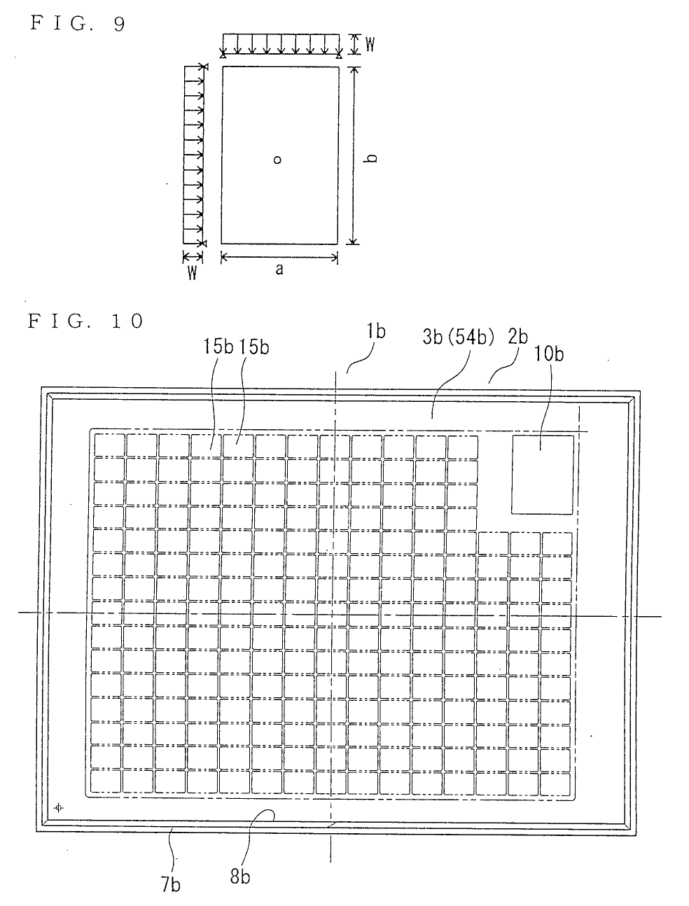

As a finger comes near to each reflection electrode during a touch input operation, a portion of high frequency current drains to the earth via the finger 21 so that a reception signal level at the corresponding detector electrode changes toward a negative direction (a change [symbol] in FIG. 6). This identifies X and Y coordinate positions. As the finger touches and depresses the one flat plate 3, the reflection electrode comes near the input/output electrode 16 of the other flat plate 4 and high frequency current from the drive electrode 17 to detector electrode 18 increases. A change in the signal level toward a positive direction (a change □ in FIG. 6) is measured to identify an ON operation only for this electrode pair. This identification operation at two stages can prevent multi-point inputs caused by erroneous operation at a touch panel, i.e., erroneous operation of so-called “touching wrong key”. Gas is used as fluid sealed in the gap 6 between the upper and lower movable flat plates 3 and 4, and a pressure of the gas is set slightly lower or higher than an atmospheric pressure. The gas provides a function of stroke and comfortable depression sense when a switch is depressed. The more the one flat plate 3 is depressed, the higher the pressure becomes to obtain reliable depression sense. As the finger is released, the switch resumes the initial position to obtain necessary stroke.

In this embodiment, a deflection amount of a plate glass used as the upper movable plate (flat plate 3) shown in FIG. 1 was calculated by using a pressure value of charged gas as a parameter.

As shown in FIG. 9, the gas cell can be considered that a uniformly distributed load by an atmospheric pressure is exerted on a four-side supported rectangle plate, and this corresponds to the following calculation methods.

In the case of a uniformly distributed load on four-side supported rectangle plate,

σc=β₁(W·a²)/t² (1)

εc=α:(W·a⁴)/(E·τ³) (2)

A white circle symbol ◯ in FIG. 9 indicates a point where a maximum bending pressure and a maximum deflection occur.

A mass of plate glass is calculated for W and P excepting that a load is applied along a horizontal direction.

Refer to Table 1 for coefficient values.

TABLE 1
Coefficient values: β₁ α₁

| | | | | | | | | | | | | | | | |
|---|---|---|---|---|---|---|---|---|---|---|---|---|---|---|---|
| b/a | 1.0 | 1.1 | 1.2 | 1.3 | 1.4 | 1.5 | 1.6 | 1.7 | 1.8 | 1.9 | 2.0 | 3.0 | 4.0 | 5.0 | ∞ |
| β₁ | 0.272 | 0.318 | 0.362 | 0.403 | 0.441 | 0.475 | 0.507 | 0.535 | 0.560 | 0.538 | 0.603 | 0.711 | 0.740 | 0.748 | 0.750 |
| α₁ | 0.046 | 0.055 | 0.064 | 0.073 | 0.081 | 0.088 | 0.094 | 0.100 | 0.106 | 0.111 | 0.115 | 0.139 | 0.146 | 0.147 | 0.148 |

### Description of Symbols

σ_{c}, σ_{c}: maximum bending stress (MPa) at plate center and side center of plate glass

δ_{c}, δ_{c}: maximum deflection (mm) at plate center and side center of plate glass

a: length of shorter side of rectangle, radius of circle, or free side length of two-side or three-side supported rectangle (mm)

b: length of longer side of rectangle, or support side length of two-side or three-side supported rectangle (mm)

t: thickness of plate glass (mm)

W: uniformly distributed load (MPa)

P: concentrated load

β₁ to β₄: coefficient determined by side length ratio b/a

α₁ to α₄: coefficient determined by side length ratio b/a

E: Young's modulus of plate glass 7.16×10⁴ (MPa)

Equation (2) was used for calculating deflection δ.

Rectangular plate glass was assumed having a shorter side a of 200 mm and a longer side b of 300 mm

First, a deflection amount per pressure of 1 gr/cm² is calculated.

| | |
|---|---|
| Pressure: 1 gr/cm² = 0.001 MPa | Symbol W |
| Shorter side: 200 mm | Symbol a |
| Longer side: 300 mm | Symbol b |
| Coefficient | Symbol α₁ |
| determined by b/a 0.088 | |
| Plate glass thickness 0.7 mm | Symbol t |
| Young's modulus of | Symbol E |
| plate glass 7.16 × 10⁴ MPa | |

The above constants are substituted in Equation (2):

δ=0.088×(0.0001×200⁴)/(7.16×10⁴×0.7³)=0.572 mm

Next, a dead weight of glass plate per 1 cm² is calculated.

plate thickness 0.7 mm=0.07 cm

specific gravity=2.5

dead weight ω=0.07×2.5=0.175 gr/cm²

Since resistance of the diaphragm can be neglected relative to ω, deflection appears first at W>ω when plate glass abuts on the stopper 6 shown in FIG. 1.

This is plotted as the graph shown in FIG. 7. In order to obtain comfortable depression sense of a touch panel, it is desired that reaction force is not so large and the touch panel is used near at an air pressure balancing the dead weight of plate glass. Under this condition, an initial reaction force when the upper surface of plate glass is pushed with a finger is:

0.175×20 cm×30 cm=105 gr.

According to the Boyle-Charles' law, the reaction force increases as the plate glass is pushed further so that proper depression sense can be obtained. In this state, the upper flat plate 3 moves downward away from the stopper 8, and the deflection given by Equation (2) will not appear. If liquid is used as fluid to be filled in the gap, deflection will not appear so that it is not necessary to consider this point.

If the upper movable plate (flat plate 3) has deflection due to the pressure of sealed gas during touch input, the operation of each switch is hindered. In order to avoid this, it is essential that the upper movable plate (flat plate 3) is moved downward away from the stopper 8 while the upper movable plate (flat plate 3) is depressed. Therefore, the requisites of this invention are to depress the upper movable plate (flat plate 3) until it becomes away from the stopper.

Next, description will be made on the second embodiment.

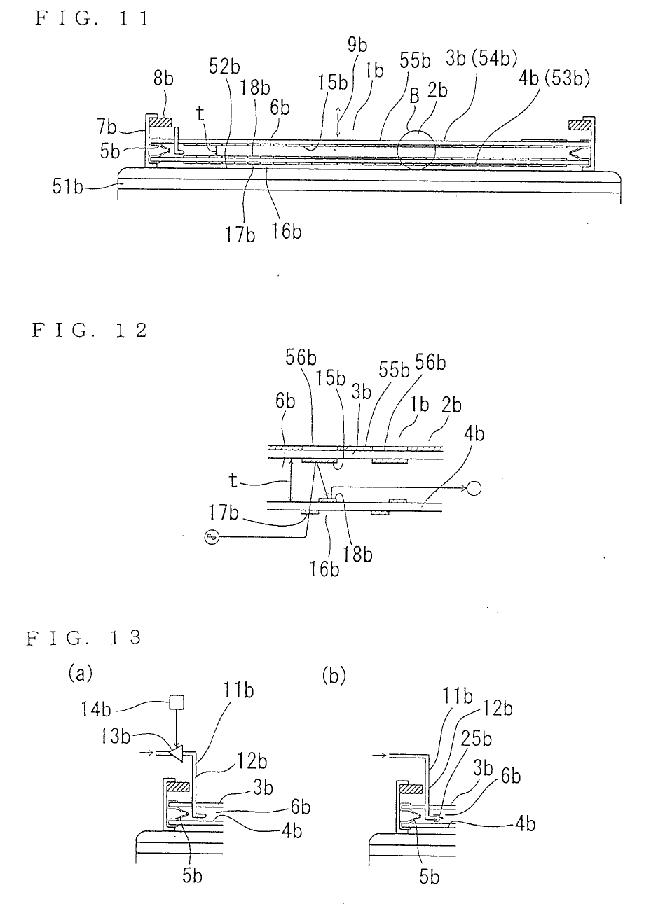

In FIGS. 10 to 12, reference numeral 1b represents a gas cell for an electrostatic induction type touch input device. The gas cell 1b for a touch input device is used by being disposed facing a display plane 52b of a display device 51b. The gas cell 1b for a touch input device has a parallel plate member 2b. The parallel plate member 2b is constituted of two plates disposed facing each other in parallel with a predetermined gap therebetween. In this embodiment, flat plates 3b and 4b are used as the two plates. Namely, the parallel plate member 2b is constituted of two flat plates 3b and 4b. The flat plates 3b and 4b are disposed facing each other in parallel at a gap 6b, and can perform relative displacement along mutually opposing directions. A peripheral portion of the parallel plate member 2b is sealed by a sealing member to be in an air-tight state. Therefore, the flat plates 3b and 4b are coupled in the state that the plates can perform relative displacement along mutually opposing directions and that gas can be accommodated in a gap 6 therebetween, the gap having a thickness of t. A thickness of each of the flat plates 3b and 4b is 0.1 mm to 10 mm, preferably 0.3 mm to 0.7 mm. For example, the thickness is 0.7 mm in this embodiment. A thickness t of the gap 6b is 0.5 mm to 3.0 mm, preferably 0.5 mm to 2.0 mm. For example, the thickness is 1.5 mm in this embodiment. In this embodiment, a diaphragm 5b is used as the sealing member. The diaphragm 5b is made of flexible material such as rubber, and as shown in FIG. 10 has a ring shape which can be fitted in the peripheral portion of the parallel plate member by one turn. The cross sectional shape in a virtual plane including the center line of the ring is curved extending into the gap 6b between the flat plates 3b and 4b. The diaphragm has a variable shape portion 21b capable of expanding and compressing to allow relative displacement of the flat plates 3b and 4b in mutually opposing directions, and parallel plate portions 22b and 23b at opposite ends of the variable shape portion 21b along mutually opposing directions. The diaphragm 5b is mounted on the peripheral portion of the parallel plate member 2b in such a manner that the peripheral portion of the flat plates 3b and 4b is squeezed between the plate portions 22b and 23b in an air-tight state. The gap 6b is sealed in such a manner that the flat plates 3b and 4b are allowed to move relatively along mutually opposing directions. Mounting the diaphragm 5b on the parallel plate member 2b by mount portions 24b considerably facilitates a mount work. The flat plates 3b and 4b are made of glass or plastic.

The peripheral portion of the parallel plate member 2b is fitted in a frame 7b at the outside of the diaphragm 5b to allow displacement of the flat plate 3b. For example, the frame 7b is made of aluminum die-cast or plastic.

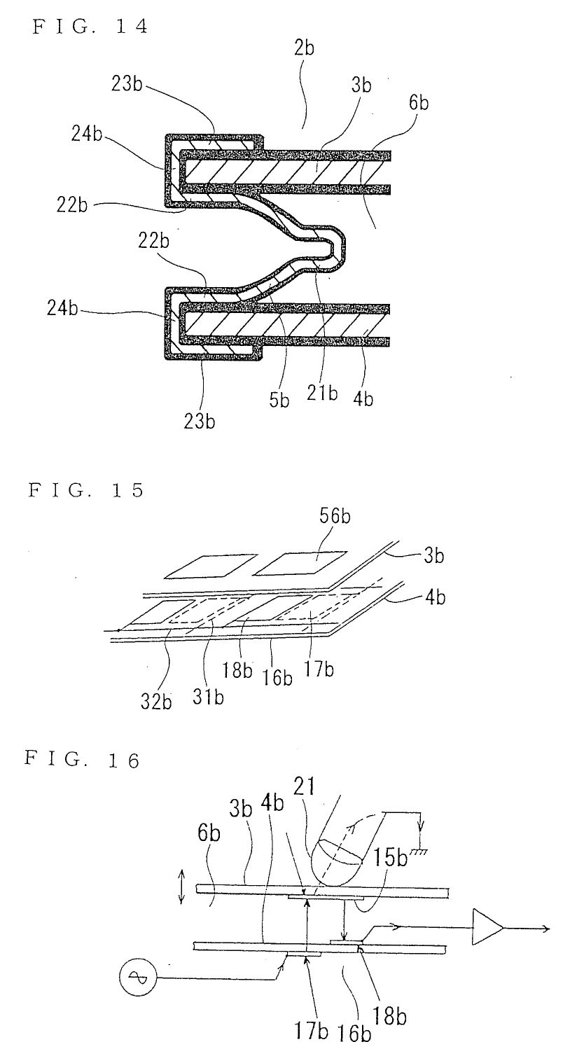

A stopper 8b is disposed between the parallel plate member 2b and frame 7b to regulate the range of relative displacement between the flat plates 3b and 4b. Gas to be filled in the gap 6b may be air. The gas is supplied into the gap 6b by a gas supply unit 11b. As shown in FIG. 13(a), the gas supply unit 11b has a pipe 12b, a valve 13b and a controller 14b. The valve 13b is opened by a signal from the controller 14b so that air can be introduced from the pipe 12b into the gap 6b. The valve 13b and controller 14b may be replaced with a rubber valve. As shown in FIG. 13(b), if the rubber valve is used for realizing a valve function, the top opening of the pipe 12b is covered and closed with the rubber valve. In this case, when air is to be supplied into the gap 6b, the upper flat plate 3b is lifted with a suction cap (not shown) so that a pressure in the gap 6b is lowered and the rubber valve 25 opens by a pressure difference and air is introduced from the pipe 12b into the gap 6b. By preparing a suction cap as an additional jig, air can be replenished always easily.

As shown in FIGS. 10. 11, 12 and 15, of the two flat plates 3b and 4b of the parallel plate member 2b, the one flat plate 3b has a number of reflection electrodes 15b disposed in a matrix shape on the inner surface thereof. An input/output electrode 16b is disposed on the inner surface of the other flat plate 4b in correspondence with each reflection electrode 15b at the position generally corresponding to the reflection electrode 15b. This input/output electrode 16b is constituted of a pair of a drive electrode 17b and a detector electrode 18b. Drive electrodes 17b disposed at the same row or column are connected to the same row or column, and detector electrodes 18b at the same column or row are connected to the same row or column.

The flat plate 4b constitutes a board 53b which is fixed to a display device 51b via the frame 7b to be described later. The flat plate 3a constitutes a touch board 54b which is an input touch operation target and can move toward the board 53b.

An outer surface of the flat plate 3b constituting the touch board 54b is covered with a shield layer 55b. Since a non-shielding window 56b is formed through the shield layer 55b at a position corresponding to the reflection electrode, the shield layer does not exist at the position corresponding to the window 56b.

The input/output electrode on the flat plate 4b constituting the board 53b is constituted of a pair of the drive electrode 17b and detector electrode 18b. Drive electrodes of respective pairs and conductive wires 31b connecting these electrodes are formed on one of the inner or outer surfaces of the flat plate 4b, in this embodiment, on the outer surface, whereas detector electrodes of respective pairs and conductive wires 32b connecting these electrodes are formed on the other surface, in this embodiment, on the inner surface. Conductive wires connecting the drive electrodes will not therefore be interfered with conductive wires connecting the detector electrodes.

These electrodes and conductive wires are made of nano material. Nano material utilizes a phenomenon that if material such as metal is changed to ultra fine particle powders (nanometer nm in diameter), the quality of material changes quite differently. For example, if indium oxide as transparent electrode material is changed to fine powders, ideal transparent electrode material can be obtained which has a transparency of near 100% and electric resistance value of infinitely zero. Since the present invention aims at realizing an optical transparency of near 100% by using air spacer, it is very effective to use electrode material having a high transparency.

This advantage is not applied to a low transparency type. In this embodiment, electrodes and conductive wires are made of mold of indium oxide ultra fine particle powders.

The operation of the gas cell 1b for a touch input device constructed as above is as follows.

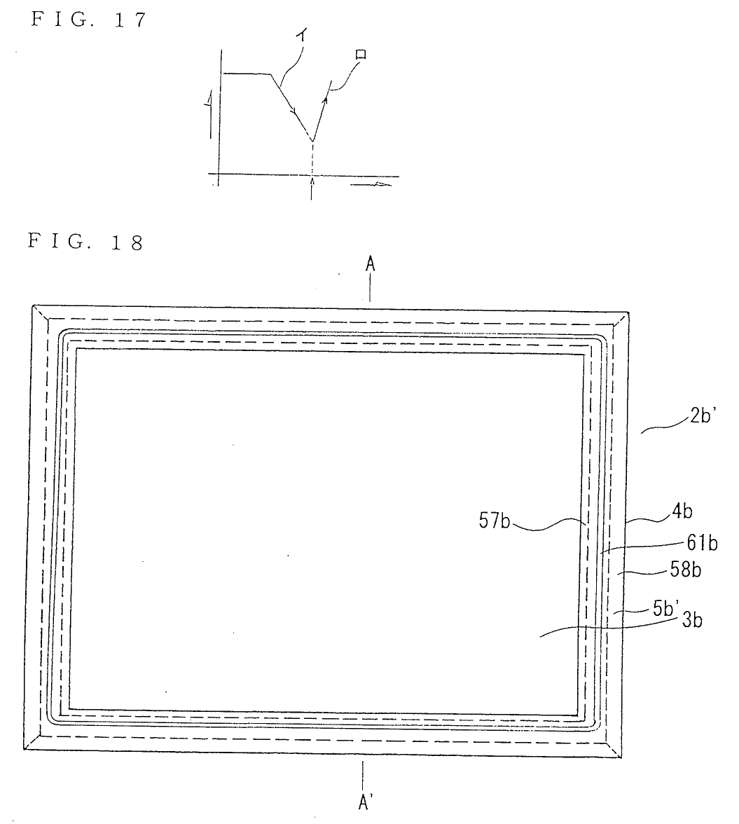

As shown in FIGS. 16 and 17, as a finger comes near to each reflection electrode during a touch input operation, a portion of high frequency current drains to the earth via the finger 21 so that a reception signal level at the corresponding detector electrode changes toward a negative direction (a change . . . in FIG. 17). This identifies X and Y coordinate positions. As the finger touches and depresses the one flat plate 3b, the reflection electrode moves toward the input/output electrode 16b of the other flat plate 4b and high frequency current from the drive electrode 17b to detector electrode 18b increases. A change in the signal level toward a positive direction (a change . . . in FIG. 17) is measured to identify an ON operation only for this electrode pair. This identification operation at two stages is performed by a finger. Consider now that a palm or substance other than the finger is placed at the same time on the panel. In this case, an erroneous input “touching wrong key” on the touch panel can be prevented by configuring switch elements having the characteristics that the direction of a pressure change caused by finger depression is opposite to the direction of gravity caused by a palm or substance, in terms of the gas pressure in the cell and the Pascal's law. Gas is used as fluid sealed in the gap 6b between the upper and lower movable flat plates 3b and 4b, and a pressure of the gas is set slightly lower or higher than an atmospheric pressure. The gas provides a function of stroke and comfortable depression sense when a switch is depressed. The more the one flat plate 3b is depressed, the higher the pressure becomes to obtain reliable depression sense. As the finger is released, the switch resumes the initial position to obtain necessary stroke.

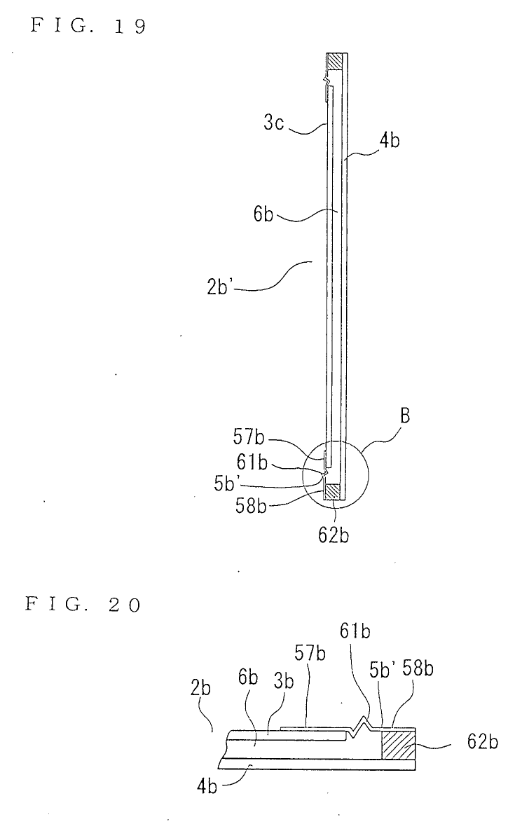

FIGS. 18 to 20 show a diaphragm 5b′ according to another embodiment. The diaphragm 5b′ has a rectangular ring shape extending over the whole circumference of one flat plate. An inner portion 57b and an outer portion 58b of the diaphragm 5b′ are of a flat shape, and an intermediate portion 61b is of a waved plate shape facilitating deformation. When a parallel plate member 2b is to be formed, one flat plate 3b is formed slightly smaller than the other flat plate 4b. A spacer 62b having a thickness corresponding to a gap 6b is bonded to the flat plate 4b in the circumferential area thereof by one turn. The outer portion 58b of the diaphragm 5b′ is bonded to the upper surface of the spacer 62b, and the inner portion 57b of the diaphragm 5b′ is bonded to the circumferential area of the one flat plate 3b. In this manner, the parallel plate member 2b can be formed. By utilizing expansion/compression of the intermediate portion 61b of the diaphragm 5b′, the one flat plate 3b can conduct displacement relative to the other flat plate 4b along mutually opposing directions.

1. A gas cell for a touch input device comprising:
a parallel plate member including two flat plates disposed in parallel and facing each other and having a plurality of electrodes;
a sealing member for sealing a peripheral portion of said parallel plate member in such a manner that gas is accommodated in a gap between said two flat plates in a state that said two flat plates can conduct relative displacement along opposing directions; and
a frame for holding the peripheral portion of said parallel plate member in such a manner that said two flat plates can conduct said relative displacement along opposing directions.

2. The gas cell for a touch input device according to claim 1, wherein said sealing member is a diaphragm.

3. The gas cell for a touch input device according to claim 1, further comprising a gas supply unit for supplying gas into the gap between said two flat plates.

4. The gas cell for a touch input device according to claim 1, wherein said two flat plates are made of transparent material.

5. The gas cell for a touch input device according to claim 1, wherein said two flat plates are made of glass or plastic.

6. The gas cell for a touch input device according to claim 1, wherein reflection electrodes are disposed in a matrix shape on one of said two flat plates, and input/output electrodes are disposed on the other of said two flat plates at positions corresponding to said reflection electrodes.

7. The gas cell for a touch input device according to claim 1, wherein said reflection electrodes and said input/output electrodes are made of transparent material.

8. The gas cell for a touch input device according to claim 6, wherein each of said input/output electrodes includes a drive electrode and a detector electrode.

9. The gas cell for a touch input device according to claim 8, wherein each of said input/output electrodes is a pair of the drive electrode and the detector electrode.

10. The gas cell for a touch input device according to claim 8, wherein said drive electrodes disposed on the same row or column are connected to the same row or column, and said detector electrodes disposed on the same row or column are connected to the same row or column.

11. The gas cell for a touch input device according to claim 1, further comprising a stopper for regulating a maximum displacement amount of said relative displacement of said two flat plates.

12. A gas cell for an electrostatic induction type touch input device comprising:
a parallel plate member including two flat plates disposed in parallel and facing each other and having a plurality of conductive wires and electrodes;
a sealing member being mounted on a peripheral portion of said parallel plate member for sealing the peripheral portion of said parallel plate member in such a manner that gas is accommodated in a gap between said two flat plates in a state that said two flat plates can conduct relative displacement along opposing directions; and
a frame for holding the peripheral portion of said parallel plate member in such a manner that said two flat plates can conduct said relative displacement along opposing directions.

13. The gas cell for an electrostatic induction type touch input device according to claim 12, wherein said sealing member is a diaphragm.

14. The gas cell for an electrostatic induction type touch input device according to claim 12, further comprising a gas supply unit for supplying gas into the gap between said two flat plates.

15. The gas cell for an electrostatic induction type touch input device according to claim 12, wherein said two flat plates are made of transparent material.

16. The gas cell for an electrostatic induction type touch input device according to claim 12, wherein said two flat plates are made of glass or plastic.

17. The gas cell for an electrostatic induction type touch input device according to claim 12, wherein reflection electrodes are disposed in a matrix shape on one of said two flat plates, and input/output electrodes are disposed on the other of said two flat plates at positions corresponding to said reflection electrodes.

18. The gas cell for an electrostatic induction type touch input device according to claim 12, wherein said conductive wires and said electrodes are made of transparent material.

19. The gas cell for an electrostatic induction type touch input device according to claim 17, wherein each of said input/output electrodes includes a drive electrode and a detector electrode.

20. The gas cell for an electrostatic induction type touch input device according to claim 17, wherein each of said input/output electrodes is a pair of the drive electrode and the detector electrode, said drive electrode is formed on one surface of said other flat plate, and said detector electrode is formed on the other surface of said other flat plate.

21. The gas cell for an electrostatic induction type touch input device according to claim 17, wherein said drive electrodes disposed on the same row or column of said matrix are connected to said conductive wires disposed in correspondence with the same row or column, and said detector electrodes disposed on the same row or column of said matrix are connected to said conductive wires disposed in correspondence with the same row or column.

22. The gas cell for an electrostatic induction type touch input device according to claim 12, further comprising a stopper for regulating a maximum displacement amount of said relative displacement of said two flat plates.

23. The gas cell for an electrostatic induction type touch input device according to claim 12, wherein said electrodes or said conductive wires are made of nano-material.

24. The gas cell for an electrostatic induction type touch input device according to claim 12, wherein said electrodes and said conductive wires are formed by molding ultra fine particle powders of indium oxide.

25. The gas cell for an electrostatic induction type touch input device according to claim 17, wherein:
said reflection electrodes are disposed in a matrix shape on an inner surface of one of said two flat plates, said input/output electrodes are disposed in a matrix shape on the other of said two flat plates, and a shield layer is formed on an outer surface of one of said two flat plates, having a number of non-shielding windows disposed at positions corresponding to said reflection electrodes; and
each of said input/output electrodes includes a pair of a drive electrode and a detector electrode, said drive electrode of each pair is formed on one of inner and outer surfaces of the other of said two flat plates, and said detector electrode of each pair is formed on the other of said inner and outer surfaces.

26. The gas cell for an electrostatic induction type touch input device according to claim 17, wherein said conductive wires interconnecting said drive electrodes disposed on the other of said two flat plates are formed on one of inner and outer surfaces of the other of said two flat plates, and said conductive wires interconnecting said detector electrodes disposed on the other of said two flat plates are formed on the other of the inner and outer surfaces of the other of said two flat plates.

27. The gas cell for an electrostatic induction type touch input device according to claim 13, wherein said diaphragm in a state mounted on said parallel plate member includes a variable shape portion positioned between said two flat plates of said parallel plate member and being capable of deformation allowing said relative displacement along the opposing directions, and mount portions positioned at opposite ends of said variable shape portion along the opposing directions and squeezing the peripheral portion of said parallel plate member.

28. The gas cell for an electrostatic induction type touch input device according to claim 14, wherein said gas supply unit includes a gas supply tube having at one end a gas supply opening extending in the gap between said two flat plates and a rubber check valve attached to said gas supply tube to close said gas supply opening and to open said gas supply opening by a pressure difference between a gas source and the gap to allow only a gas flow from the gas source into the gap.

29. The gas cell for an electrostatic induction type touch input device according to claim 12, wherein the gas cell has the characteristics that a direction of a signal change caused by a finger near said parallel plate member during an input operation is opposite to a direction of a signal change caused by one of said two flat plates of said parallel plate member moving toward the other of said two flat plates.
